(19) United States
(12) Patent Application Publication
(10) Pub. No.: US 2026/0048742 A1
(43) Pub. Date: Feb. 19, 2026

(54) VEHICULAR DRIVING ASSIST SYSTEM WITH ADAPTIVE CRUISE CONTROL

(71) Applicant: Magna Electronics Inc., Auburn Hills, MI (US)

(72) Inventors: Arpit Awathe, Rochester Hills, MI (US); Tejas Murlidhar Varunjikar, Troy, MI (US)

(21) Appl. No.: 19/299,402

(22) Filed: Aug. 14, 2025

Related U.S. Application Data
(60) Provisional application No. 63/683,740, filed on Aug. 16, 2024.

(51) Int. Cl. B60W 30/16; B60W 10/04; B60W 10/18; B60W 30/17

(52) U.S. Cl. CPC B60W 30/162; B60W 10/18; B60W 30/17; B60W 10/04; B60W 2420/403; B60W 2420/408; B60W 2420/54; B60W 2422/00; B60W 2520/10; B60W 2552/53; B60W 2554/4041; B60W 2554/4042; B60W 2554/802; B60W 2710/18; B60W 2720/103; B60W 2720/106; B60W 2754/30

(57) ABSTRACT

A vehicular control system of an equipped vehicle determines presence of a leading vehicle in front of the equipped vehicle and within a traffic lane along which the equipped vehicle is traveling, and determines distance between the equipped vehicle and the leading vehicle. The vehicular control system, responsive to (i) determining that the leading vehicle is stopped in front of the equipped vehicle or traveling at speed that is less than a threshold speed and (ii) the determined distance being greater than a threshold distance, determines a velocity profile. With the equipped vehicle at a distance from the leading vehicle that is greater than the threshold distance, the system controls speed of the equipped vehicle based on the determined velocity profile, and determines a distance profile based on (a) speed of the equipped vehicle and (b) the determined distance between the equipped vehicle and the leading vehicle.

### CROSS REFERENCE TO RELATED APPLICATION

The present application claims the filing benefits of U.S. provisional application Ser. No. 63/683,740, filed Aug. 16, 2024, which is hereby incorporated herein by reference in its entirety.

### FIELD OF THE INVENTION

The present invention relates generally to a vehicle sensing system for a vehicle and, more particularly, to a vehicle sensing system that utilizes one or more cameras and/or radar sensors at a vehicle.

### BACKGROUND OF THE INVENTION

Use of imaging sensors in vehicle imaging systems is common and known. Examples of such known systems are described in U.S. Pat. Nos. 5,949,331; 5,670,935 and/or 5,550,677, which are hereby incorporated herein by reference in their entireties.

### SUMMARY OF THE INVENTION

A vehicular driving assist system includes a sensor that is disposed at a vehicle equipped with the vehicular driving assist system and that senses exterior of the vehicle and that is operable to capture sensor data. The vehicular driving assist system also includes an electronic control unit (ECU) that has electronic circuitry and associated software. The sensor data captured by the sensor is transferred to the ECU, which has a data processor for processing sensor data captured by the sensor. The vehicular driving assist system, via processing at the ECU of captured sensor data, determines presence of a leading vehicle in front of the equipped vehicle and within a traffic lane along which the equipped vehicle is traveling. The vehicular driving assist system, responsive to determining presence of the leading vehicle in front of the equipped vehicle and within the traffic lane along which the equipped vehicle is traveling, determines distance between the equipped vehicle and the leading vehicle. Responsive to (i) determining that the leading vehicle is stopped in front of the equipped vehicle or traveling at speed that is less than a threshold speed and (ii) the determined distance being greater than a threshold distance, the vehicular driving assist system determines a velocity profile for the equipped vehicle to follow based on (a) speed of the equipped vehicle and (b) the determined distance between the equipped vehicle and the leading vehicle. With the equipped vehicle at a distance from the leading vehicle that is greater than the threshold distance, and with speed of the equipped vehicle being greater than speed of the leading vehicle, the vehicular driving assist system controls speed of the equipped vehicle based on the determined velocity profile to control slowing of the equipped vehicle as the equipped vehicle approaches the leading vehicle. While controlling speed of the equipped vehicle based on the determined velocity profile as the equipped vehicle approaches the leading vehicle, and responsive to the determined distance between the equipped vehicle and the leading vehicle is less than or equal to the threshold distance, the vehicular driving assist system determines a distance profile for the equipped vehicle to follow based on (a) speed of the equipped vehicle and (b) the determined distance between the equipped vehicle and the leading vehicle. With the equipped vehicle being at a distance from the leading vehicle that is less than or equal to the threshold distance, the vehicular driving assist system controls speed of the equipped vehicle based on the determined distance profile to establish and maintain a target gap between the equipped vehicle and the leading vehicle.

These and other objects, advantages, purposes and features of the present invention will become apparent upon review of the following specification in conjunction with the drawings.

### BRIEF DESCRIPTION OF THE DRAWINGS

FIG. 1 is a plan view of a vehicle with a vehicular driving assist system that incorporates sensors;

FIG. 2 is a schematic of an adaptive cruise control algorithm;

FIG. 3 is a schematic of an equipped vehicle stopping for a stationary leading vehicle;

FIG. 4 are plots of exemplary acceleration and velocity trajectory profiles with the equipped vehicle initially having zero acceleration;

FIG. 5 are plots of exemplary acceleration and velocity trajectory profiles with the equipped vehicle initially having a positive acceleration;

FIG. 6 is a schematic of longitudinal control module;

FIG. 7 is a schematic of a trajectory-based controller; and

FIG. 8 is a schematic of a distance-based controller.

### DESCRIPTION OF THE PREFERRED EMBODIMENTS

A vehicle sensing system and/or driver or driving assist system or vehicular driving assist system operates to capture sensor data representative of the exterior of the vehicle and may process the captured sensor data to detect objects at or near the vehicle and in the area of the vehicle, such as to assist a driver of the vehicle in maneuvering the vehicle in a forward or rearward direction. The driving assist system includes a processor or processing system that is operable to process sensor data that is transferred to the processor from one or more sensors (e.g., radar sensors, lidar sensors, ultrasonic sensors, imaging sensors, etc.).

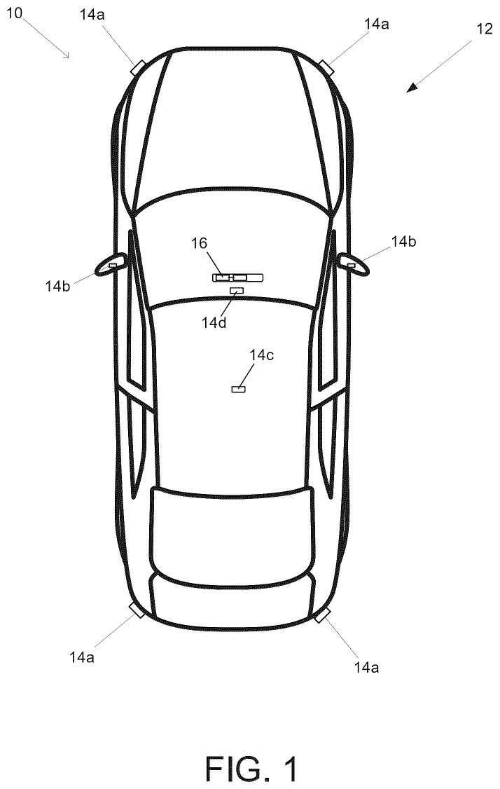

Referring now to the drawings and the illustrative embodiments depicted therein, a vehicle 10 (FIG. 1) includes a driving assistance system or control system 12 that includes at least one exterior viewing sensor, such as one or more radar sensors 14a, sideward cameras 14b, lidar sensors 14c, forward-viewing cameras 14d, ultrasonic sensors, and/or any other imaging sensor. Each sensor 14a-d may be disposed at, for example, one or both exterior side mirrors of the vehicle, at one or more corners of the vehicle (e.g., at a corner of a bumper), at a windshield of the vehicle (e.g., the forward-viewing camera 14d may be disposed at an in-cabin side of the windshield and viewing forward of the vehicle through the windshield), and/or at a rooftop of the vehicle. The sensor(s) capture sensor data representative of the scene occurring exterior of the vehicle (e.g., at least forward, and/or rearward of the vehicle). The driving assistance system or control system 12 includes a control or electronic control unit (ECU) 16 having electronic circuitry and associated software, with the electronic circuitry including a data processor or image processor that is operable to processor sensor data captured by the sensors, whereby the vehicular sensing system or ECU may detect or determine presence of objects or the like and alert an occupant of the vehicle and/or control movement of the vehicle. The data transfer or signal communication from the camera to the ECU may comprise any suitable data or communication link, such as a vehicle network bus or the like of the equipped vehicle.

Advanced driver assistance systems (ADAS) gather information about the surrounding environment through various sensors. This information is utilized by multiple features such as adaptive cruise control (ACC), lane centering, and lane keep assist to assist the driver while operating the vehicle. ACC specifically utilizes data from sensors such as, cameras, radar, ultrasonic sensors, and lidar, incorporating object and lane-marking information for longitudinal control.

The ACC feature helps the driver maintain longitudinal control of the vehicle by maintaining a vehicle speed set by the driver while also slowing down or speeding up based on the presence of other vehicles (i.e., target or leading vehicles) in the path of the equipped vehicle. Typically, the driver selects a gap to be maintained between the equipped vehicle and other vehicles in the path of the equipped vehicle. If there is an object (e.g., leading vehicle) traveling in front of the equipped vehicle at a speed that is slower than the desired speed set by the driver, the ACC system may reduce the speed of the vehicle to maintain the selected gap (i.e., will slow the vehicle to match the speed of the leading vehicle or stop the vehicle if the leading vehicle is stopped). Moreover, acceleration and deceleration profiles may be calibrated by the driver based on in-vehicle comfort metrics. For example, a non-aggressive in-vehicle comfort metric may restrict the ACC system from accelerating or decelerating the vehicle above a particular threshold (e.g., a maximum acceleration/deceleration in m/s²). On the other hand, an aggressive in-vehicle comfort metric may enable the ACC system to accelerate or decelerate the vehicle above the particular threshold.

For example, the user-selected gap may instruct the ACC feature to maintain a twenty-foot (or fifty-foot or more) distance between the equipped vehicle and another vehicle ahead of the equipped vehicle (the target or leading vehicle). Alternatively, the user-selected gap indicates the ACC should maintain a gap or distance equivalent to a period of time (e.g., 1 second, 2 seconds, 3 seconds, etc.). This gap can be adjusted dynamically while the equipped vehicle follows the leading vehicle. If the leading vehicle stops, the ACC ensures that the equipped vehicle halts or stops at a specified distance or gap referred to as the stopping distance (i.e., the distance between the equipped vehicle and the leading vehicle when both vehicles are stopped). The stopping distance may be the same or different distance as the gap between the equipped vehicle and the leading vehicle while the vehicles are moving (e.g., traveling at a non-zero velocity). Moreover, the driver may select or provide the stopping distance. Once the leading vehicle resumes movement, the ACC may increase speed such that the equipped vehicle remains the set distance or time gap from the leading vehicle.

Stopping at a safe distance away from a stationary leading vehicle is an important function of ACC. These scenarios may occur on urban roads at traffic lights where stationary vehicles are present and stopped or stopping at the traffic light, or on highways during traffic jams such that the leading vehicles are traveling at low velocities or even zero velocity (i.e., stopped). A slight error in ACC output commands may lead to accidents. For example, an accident may occur when failing to stop the equipped vehicle before the equipped vehicle collides with the leading stationary vehicle. If the ACC output is too aggressive, the vehicle may stop prematurely at a distance greater than the stopping distance or the deceleration may be uncomfortable for the driver or other occupants of the vehicle (e.g., deceleration of the vehicle exceeds the particular threshold of the in-vehicle comfort metric). Therefore, ensuring a smooth transition to a complete stop while maintaining a safe stopping distance from the leading vehicle is an important aspect of the ACC system.

In some scenarios, while the equipped vehicle is following the leading vehicle at a specified gap, the driver may dynamically adjust the specified gap. During transitions between different gap settings, the ACC ensures smooth operation of the equipped vehicle and gradually adjusts the distance between the two vehicles by accelerating or decelerating the equipped vehicle. Additionally, the ACC reduces the vehicle's speed on curved roads to limit lateral acceleration by determining necessary acceleration or deceleration based on maintaining the gap, velocity, or stopping at a set distance from a stationary leading vehicle. This information may be relayed to a low-level controller that adjusts the velocity of the vehicle by applying the brakes to decrease the speed of the vehicle or providing a torque command to increase the speed of the vehicle. This output may be a propulsion control command that controls a propulsion system of the vehicle, such as an acceleration command (e.g., with positive, zero, or negative values), or the output may be a braking command, or a combination of acceleration and braking commands or an equivalent form.

Implementations herein are directed towards speed or longitudinal vehicle control using information about objects and lanes (e.g., obtained by processing sensor data captured by one or more sensors disposed at the vehicle) in the surroundings of the vehicle to follow a leading object ahead while maintaining a desired or target gap from the leading vehicle (i.e., a leading vehicle that is traveling ahead of the equipped vehicle and in the same lane as the equipped vehicle) which is set by the driver of the vehicle. To achieve this, the ACC system may account for uncertainties and disturbances, such as road grade and late detection of objects that are already close to the equipped vehicle. Moreover, the longitudinal vehicle control may use or process information about objects and lanes in the area surrounding the equipped vehicle to stop for stationary leading objects at a safe stopping distance away from the stationary leading objects.

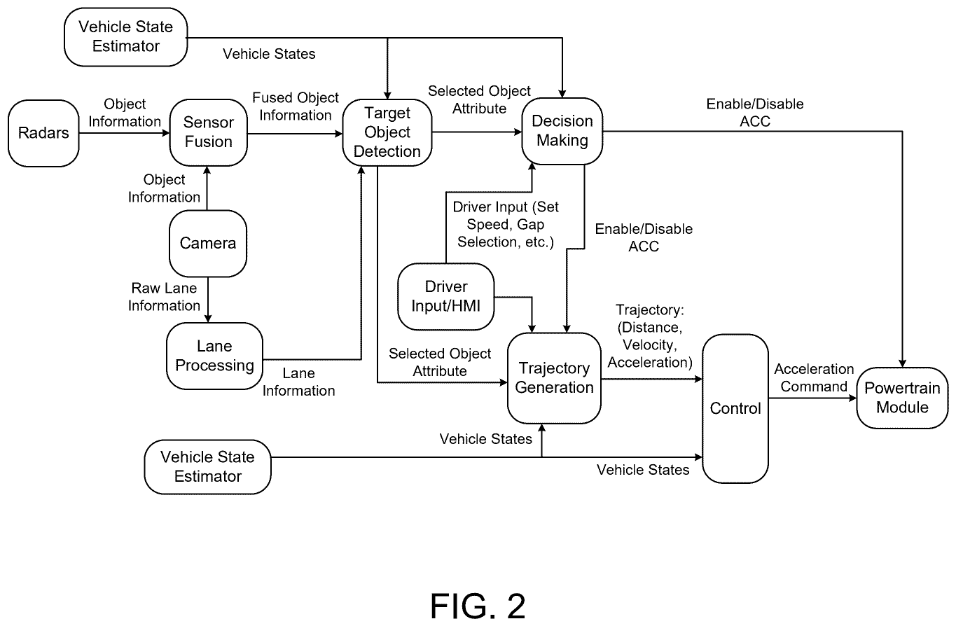

FIG. 2 illustrates an example ACC system. The ACC system may include one or more cameras where hardware and/or software of the camera transmits raw lane and front object data, including lane coefficients, quality, relative position of objects, velocity, acceleration, object type, etc. The ACC system may additionally or alternatively include one or more radar sensors where hardware and software of the radar sensor transmits raw object data, such as relative positions of objects, velocity, acceleration, object type, etc. The ACC system optionally uses sensor fusion to integrate object data from multiple sensors to accurately determine object position and various parameters, such as pose, velocity, acceleration, etc. For example, the system may include a forward-viewing camera and the system may process image data captured by the forward-viewing camera to determine lane markers of traffic lanes on the road along which the vehicle is traveling. The system may determine a leading vehicle on the road ahead of the equipped vehicle, such as via processing of image data captured by the forward-viewing camera and/or sensor data captured by a forward-sensing sensor (such as a forward-sensing radar sensor or forward-sensing lidar sensor or forward-sensing ultrasonic sensor). Based on the determined traffic lanes and the determined leading vehicle, the distance to the leading vehicle is determined by processing sensor data captured by the forward-sensing sensor. The data transmitted from these sensors to the ECU 16 may represent various attributes of detected objects and lane features within the operational environment of the equipped vehicle. The sensor fusion module may combine the diverse raw sensor data to create a more robust and accurate representation of the vehicle's surroundings, compensating for individual sensor limitations and enhancing overall perception reliability.

The ACC system may also include a vehicle state estimator that estimates states (i.e., speed and yaw rate) of the equipped vehicle. The state of the equipped vehicle may account for the current state and external factors (e.g., road gradient). The ACC system may perform lane processing by processing raw lane data to filter out low-confidence lane markings, noise, and other disturbances to generate processed lane information. This processing generates refined lane information, which may include lane boundary positions, curvature, and lane width, enabling the system to accurately determine the vehicle's position within a traffic lane. In some examples, the ACC system performs leading object selection that identifies a leading object or leading objects that the ACC system should focus on from the surrounding objects. For example, the leading object may be another vehicle traveling in the same lane as the equipped vehicle (i.e., a leading vehicle). The driver input or human machine interface (HMI) module receives various input signals from the driver and sends to the ACC system the signals related to turning the ACC system on or off, selecting the desired or target gap settings or stopping distances, etc.

A decision making module uses vehicle states (e.g., vehicle speed, yaw rate, etc.), leading object details, and/or driver input to determine whether to enable or disable the ACC feature. The trajectory generation module determines a predicted vehicle path or trajectory of the equipped vehicle in terms of various vehicle states (e.g., distance, velocity, and/or acceleration) for the equipped vehicle to follow. The control module uses the desired or leading vehicle trajectory and current vehicle states to generate longitudinal acceleration commands for the vehicle to follow the intended trajectory. The powertrain or propulsion module includes hardware and software which applies torque commands to achieve the commanded longitudinal acceleration thereby enabling the ADAS features for longitudinal control.

The ACC system may send commands for the equipped vehicle to stop at a certain distance (i.e., the stopping distance) from a stationary vehicle. Calculating the deceleration command when a stationary vehicle is detected may be challenging. That is, it may seem that simple formulas that illustrate the relationships between speed (i.e., velocity), distance, acceleration, and time can be used to calculate the acceleration command for ACC. These formulas often assume a constant acceleration of the leading vehicle. However, this assumption does not accurately reflect real-world scenarios. That is, during an actual stopping event, deceleration (e.g., deceleration of the equipped vehicle and the leading vehicle) is not constant and may vary based on the distance between the equipped vehicle and the leading vehicle. Typically, when a driver manually stops the vehicle by applying pressure to the brake pedal, the driver initially applies aggressive braking and then adjusts by releasing the brake pedal slightly to reduce braking intensity. Towards the end of the stopping process, the driver nearly fully releases the brake pedal and only a slight vehicle hold torque (e.g., brake pedal pressure) is applied. Therefore, the acceleration or deceleration profile of the equipped vehicle in such cases is non-linear. Moreover, the entire manual deceleration process by the driver is smooth and continuous. That is, the driver smoothly brings the vehicle from its current velocity and acceleration to zero velocity and acceleration. Thus, the goal of ACC systems is to replicate the smooth continuous deceleration of the equipped vehicle to emulate an actual human driving experience. To that end, the ACC system may continuously adjust the acceleration command provided to the powertrain module.

To smoothly bring the vehicle to a stop from the current velocity of the vehicle and within a specified distance of a leading vehicle, the ACC system maintains continuity (e.g., a continuous deceleration profile) throughout the process to ensure comfort. Thus, the ACC system may generate a velocity profile based on distance rather than time, as the vehicle needs to stop within a specific distance from stationary leading vehicles. The velocity profile directs the vehicle to decelerate gradually and come to a stop at the predetermined distance (i.e., the stopping distance) from the leading vehicle. In some examples, the predetermined distance that the equipped vehicle stops from the leading vehicle includes a range of distances (e.g., provided by the driver) between a minimum distance and a maximum distance. Following this velocity profile enables the equipped vehicle to transition smoothly from its initial velocity to zero velocity while achieving a controlled stop.

After generating the velocity profile, the role of the controller may shift to maintaining the velocity of the equipped vehicle in accordance with the generated velocity profile. The velocity profile provides a seamless transition from the initial state of the equipped vehicle (e.g., the current velocity of the vehicle at a current distance from the leading vehicle) to the final state of the equipped vehicle (e.g., zero velocity at the specified stopping distance from the leading vehicle). In some implementations, the ACC system generates an acceleration profile with respect to distance in addition to, or in lieu of, the velocity profile to assist the controller in tracking the velocity.

Inputs to the velocity and acceleration profile generator may include the current state of the equipped vehicle, such as velocity, longitudinal acceleration, and distance from the leading vehicle. In some implementations, the velocity profile or trajectory is tailored based on comfort levels and driving behavior. For example, the driver may select to initiate braking only when the stationary object is nearby and then apply aggressive braking as the equipped vehicle approaches the stationary object, or select to start braking gradually when the leading vehicle is further ahead over a longer period of time.

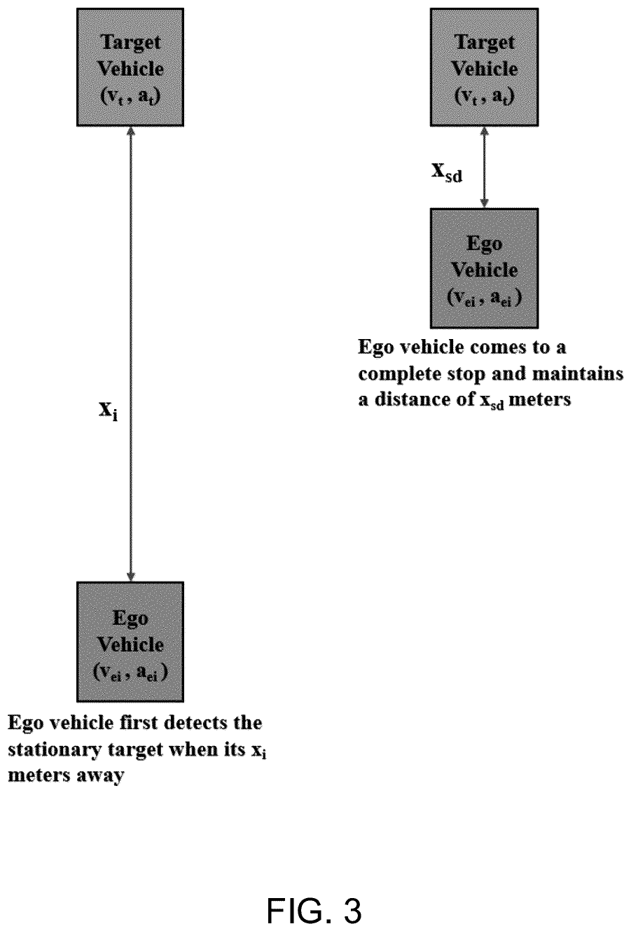

FIG. 3 illustrates a scenario where the equipped vehicle (i.e., equipped vehicle or host vehicle) detects a stationary leading vehicle at a distance (xᵢ) from the equipped vehicle. In this scenario, the ACC system instructs the equipped vehicle to come to a complete stop (e.g., zero velocity) when the equipped vehicle is at a distance (x_{sd}) from the stationary leading vehicle. As used herein:
vₑᵢ=initial equipped vehicle velocity
aₑᵢ=initial equipped vehicle acceleration
xᵢ=distance from leading vehicle
vₜ=leading vehicle velocity
aₜ=leading vehicle acceleration
x_{sd}=stopping distance from leading vehicle
aₓ=the acceleration profile of the equipped vehicle at any distance (x) from its initial state, where 0<=x<xᵢ
vₓ=The velocity profile of the equipped vehicle at any distance (x) from its initial state, where 0<=x<xᵢ
aₓᵢ=equipped vehicle acceleration when the equipped vehicle is at a distance (xᵢ) from the leading vehicle
vₓᵢ=equipped vehicle velocity when the equipped vehicle is at a distance (xᵢ) from the leading vehicle
a_{xsd}=equipped vehicle acceleration when the equipped vehicle is at a distance (x_{sd}) from the leading vehicle
v_{xsd}=equipped vehicle velocity when the equipped vehicle is at a distance (x_{sd}) from the leading vehicle.

The ACC system may generate a polynomial velocity trajectory to achieve a smooth transition from the initial state to the final state without any discontinuity. Using a higher polynomial degree for the velocity trajectory or profile ensures smoother and more continuous transitions between the initial state to the final state. In the scenario depicted in FIG. 3, as the equipped vehicle approaches the stationary leading vehicle, the velocity of the equipped vehicle gradually decreases and eventually reaches zero velocity when the leading vehicle is located a stopping distance (xsd) from the leading vehicle.

The ACC system may determine the initial conditions of the equipped vehicle by processing sensor data captured by one or more sensors (e.g., cameras, radar sensors, lidar, etc.) disposed at the vehicle. The initial conditions and the final conditions of the equipped vehicle may define four constraints. Namely, the initial conditions of the equipped vehicle include the velocity and acceleration of the equipped vehicle at a distance (xᵢ) from the leading vehicle, and the final conditions of the equipped vehicle include the velocity and the distance (e.g., velocity and distance equal to zero) at the stopping distance (x_{sd}). These constraints enable the ACC system to model the acceleration of the vehicle as a polynomial (e.g., cubic polynomial) and the square of the velocity of the equipped vehicle as another polynomial (e.g., quadratic polynomial) with respect to distance.

By applying these initial and final conditions (totaling four states), the ACC system may determine the coefficients of a third-order polynomial that describes the acceleration of the equipped vehicle as it approaches the stationary leading vehicle. Consequently, the integral of acceleration, which represents velocity, may be expressed in terms of a polynomial.

At any given distance x (0<=x<xi), the acceleration of the equipped vehicle may be represented as follows:

$${a}_{x} = \frac{{dv}_{x}}{dt} = {Ax}^{2} + Bx + C \qquad ( 1 )$$

The derivative of velocity with respect to time is acceleration, represented by:

$${a}_{x} = \frac{{dv}_{x}}{dt} \qquad ( 2 )$$

Since the entire polynomial trajectory is formulated with respect to the distance (x), acceleration and velocity may be related to distance. Multiplying and dividing Equation (2) by dx results in:

$${a}_{x} = \frac{dx}{dx} * \frac{{dv}_{x}}{dt} = {Ax}^{2} + Bx + C \qquad ( 3 )$$

### Rearranging Equation (3):

$${a}_{x} = \frac{dx}{dt} * {dv}_{x} = ( {Ax}^{2} + Bx + C ) dx \qquad ( 4 )$$

A polynomial equation may be arranged to represent velocity with respect to distance according to:

$${a}_{x} = ( “ vx ” ) {dv}_{x} = ( {Ax}^{2} + Bx + C ) dx \qquad ( 5 )$$

After integrating and rearranging Equation (5):

$$\frac{{( {v}_{x} )}^{2}}{2} = A \frac{{x}^{3}}{3} + B \frac{{x}^{2}}{2} + Cx + D \qquad ( 6 )$$

$$( \frac{1}{2} ) {v}_{x}^{2} = ( \frac{1}{3} ) {Ax}^{3} + ( \frac{1}{2} ) {Bx}^{2} + Cx + D \qquad ( 7 )$$

Equation (6) and (7) represent the relationship between velocity “vx” and distance x (0<=X<xᵢ).

At a distance of (xᵢ) from the leading vehicle, the initial and final conditions of the equipped vehicle may be represented by:

$${a}_{xi} = {Ax}_{i}^{2} + {Bx}_{i} + C \qquad ( 8 )$$

$$( \frac{1}{2} ) {v}_{xi}^{2} = ( \frac{1}{3} ) {Ax}_{i}^{3} + ( \frac{1}{2} ) {Bx}_{i}^{2} + {Cx}_{i} + D \qquad ( 9 )$$

When the equipped vehicle stops at distance xsd from the leading vehicle, both the acceleration and velocity of the equipped vehicle are equal to zero:

$${a}_{xsd} = 0 = {Ax}_{sd}^{2} + {Bx}_{sd} + C \qquad ( 10 )$$

$$( \frac{1}{2} ) {v}_{xsd}^{2} = 0 = ( \frac{1}{3} ) {Ax}_{sd}^{3} + ( \frac{1}{2} ) {Bx}_{sd}^{2} + {Cx}_{sd} + D \qquad ( 11 )$$

With four variables and four equations available (Equations (8), (9), (10), and (11)), the ACC system may solve for the unknowns [A, B, C, D]. The values of these unknown variables are determined by expressing [A, B, C, D] in terms of intermediary variables [N₁, N₂, N₃, N₄] due to the expected length of the resulting expressions.

$${N}_{1} = {x}_{i}^{2} - {X}_{sd}^{2} \qquad ( 12 )$$

$${N}_{2} = “ xi ” - {“ x ”}_{sd} \qquad ( 13 )$$

$${N}_{3} = 4 {x}_{sd}^{3} + 2 {x}_{i}^{3} - 6 {x}_{sd}^{2} {x}_{i} \qquad ( 14 )$$

$${N}_{4} = 3 {x}_{sd}^{2} + 3 {x}_{i}^{2} - “ 6 xsdxi ” \qquad ( 15 )$$

$$A = ( {a}_{xi} * {N}_{4} - 3 * “ vxi 2 ” * {N}_{2} / ( {N}_{1} {N}_{4} - {N}_{3} {N}_{2} ) \qquad ( 16 )$$

$$B = ( {a}_{xi} * {N}_{3} - 3 * “ vxi 2 ” * {N}_{1} ) / ( {N}_{3} {N}_{2} - {N}_{1} {N}_{4} ) \qquad ( 17 )$$

$$C = - A * {x}_{sd}^{2} - B * {“ x ”}_{sd} \qquad ( 18 )$$

$$D = - ( \frac{1}{3} ) {Ax}_{sd}^{3} - ( \frac{1}{2} ) {Bx}_{sd}^{2} - {Cx}_{sd} \qquad ( 19 )$$

Once the ACC system determines the acceleration and velocity trajectory of the equipped vehicle that defines the transition from the current vehicle state to the final vehicle state at distance (xᵢ), the next step is to define the desired or target or optimal acceleration and velocity. As discussed above, the desired acceleration (a_{d}) and desired velocity (v_{d}) are interrelated.

The desired or target acceleration and velocity are calculated by introducing a look-ahead time. Due to the overall dynamics of the system, there may be a delay between the desired acceleration and velocity and the actual acceleration and velocity achieved by the equipped vehicle. Therefore, a look-ahead time close to this delay is selected to facilitate a compensation of this delay. However, since the acceleration and velocity profile may be generated with respect to distance, the ACC system determines a look-ahead with respect to distance rather than time.

The ACC system may determine the look-ahead distance by multiplying the current velocity of the equipped vehicle by the delay of the system. In some examples, the look-ahead distance (xₗₐ) does not exceed the distance to the leading vehicle, xᵢ, xₗₐ to satisfy the condition of 0≤xₗₐ<xᵢ, and the velocity value at that point is selected accordingly.

$${a}_{d} = {Ax}_{la}^{2} + {Bx}_{la} + C \qquad ( 20 )$$

$$( 1 / 2 ) “ vd 2 ” = 0 = ( 1 / 3 ) {A ( {x}_{la} - {x}_{sd} )}^{3} + ( 1 / 2 ) {B ( {x}_{la} - {x}_{sd} )}^{2} + C ( {x}_{la} - {x}_{sd} ) + D \qquad ( 21 )$$

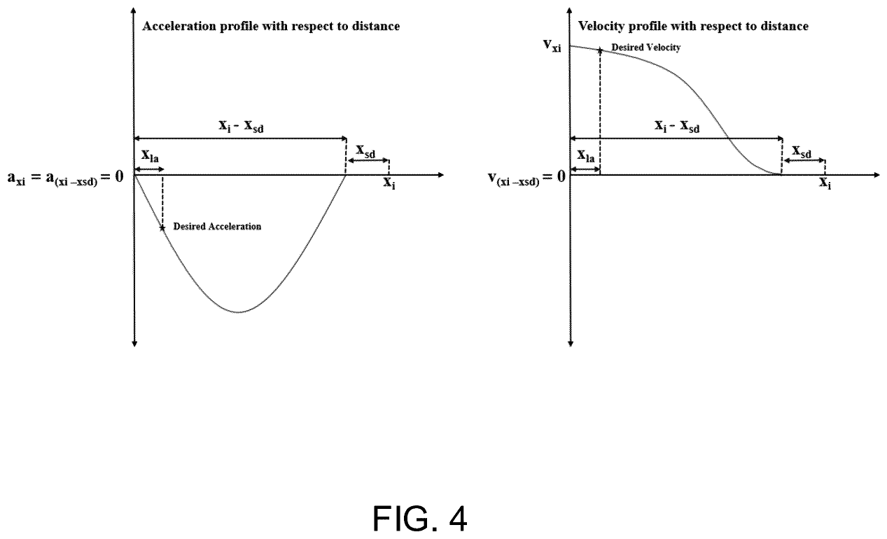

FIG. 4 illustrates an example trajectory generation and the selected desired acceleration and velocity. More specifically, FIG. 4 shows an acceleration profile and a corresponding velocity profile, both plotted with respect to the distance from a stationary leading vehicle. The horizontal axis represents the distance from the leading vehicle, ranging from an initial detection distance (xᵢ) to a final desired stopping distance (x_{sd}). The total distance over which the stopping maneuver occurs is thus (xᵢ−x_{sd}). In this scenario, the equipped vehicle initially maintains constant speed with zero acceleration. When the equipped vehicle detects a stationary leading vehicle at a distance (xᵢ) from the equipped vehicle, the trajectory generated for velocity and acceleration aims to bring the equipped vehicle to a full stop at distance (x_{sd}) from the leading vehicle. The velocity profile illustrates this by showing the vehicle's velocity starting at an initial value (vₓᵢ) at distance (xᵢ) and smoothly decreasing to zero at distance (x_{sd}). The acceleration profile depicted in FIG. 4 shows that the deceleration begins from zero deceleration, then reaches a maximum deceleration, and then gradually returns to zero deceleration as the equipped vehicle comes to a complete stop. This ensures a smooth and comfortable deceleration experience by avoiding sudden changes in acceleration (i.e., high jerk). Here, the acceleration profile follows a quadratic curve, while the velocity profile also smoothly decreases to zero. Additionally, the equipped vehicle selects a desired or target acceleration and velocity from the trajectory at a lookahead distance (xₗₐ). As depicted in both profiles, the lookahead distance (xₗₐ) is measured from the initial position (xᵢ). The controller uses the acceleration and velocity values on the generated trajectory curves at this future point (i.e., at a distance of xi-Xla from the leading vehicle) as the target commands the vehicle's control system. The lookahead mechanism helps compensate for system delays and improve tracking performance.

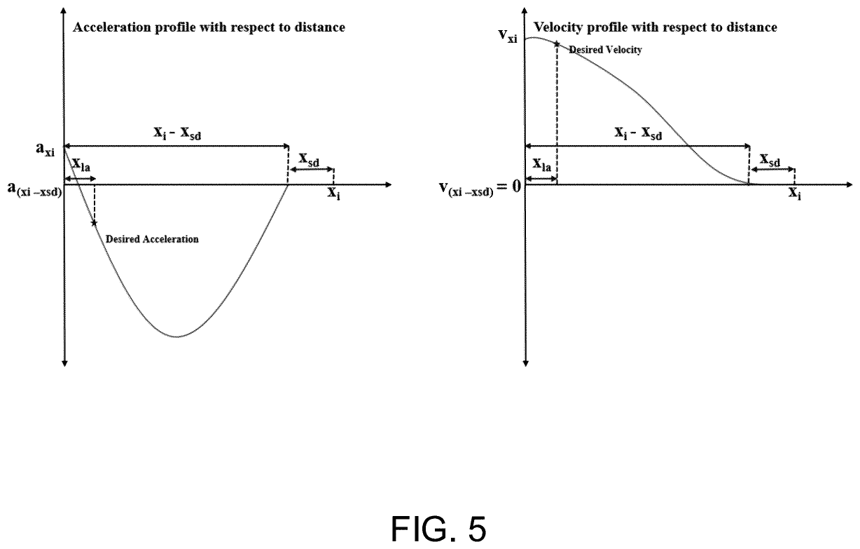

Thus, the trajectory generation algorithm is versatile and can handle various different scenarios. FIG. 5 provides another example of this versatility, illustrating scenario with different initial conditions than those shown in FIG. 4. For instance, if the equipped vehicle initially detects a stationary leading vehicle and the equipped vehicle is already accelerating, the trajectory for velocity and acceleration is generated accordingly. This scenario is precisely what is depicted in FIG. 5, where the initial acceleration (axᵢ) at distance (xᵢ) is a positive value. The objective remains to stop the equipped vehicle at distance (x_{sd}) from the leading vehicle, ensuring a smooth trajectory. FIG. 5 illustrates that the acceleration does not immediately become negative. Instead, the acceleration gradually decreases from its initial positive value before transitioning to deceleration (e.g., a negative value). The acceleration curve smoothly descends from (axᵢ), crosses the horizontal axis to become negative, reaches a point of maximum deceleration, and then returns to zero at the final stopping distance (x_{sd}). Similarly, there is a moment where the velocity briefly increases at a lower rate before decreasing. This initial increase in velocity occurs during the phase where the acceleration is positive. The velocity reaches its peak at the exact distance where the acceleration profile crosses zero, after which the velocity begins to decrease steadily as the vehicle decelerates. The result ensures that the vehicle stops at the defined distance (x_{sd}) from the leading vehicle. The entire trajectory for both acceleration and velocity are generated to have smooth and continuous profiles to ensure that the vehicle does not experience any discontinuity in its deceleration from the initial state, as depicted in FIG. 5. This continuity is a direct result of the polynomial-based trajectory generation, which ensures passenger comfort by managing the rate of change of acceleration (i.e., jerk).

From the trajectory output, the ACC system may obtain information about the desired acceleration and velocity of the equipped vehicle. The main objective is to maintain the velocity of the vehicle when a leading vehicle is moving and to bring the equipped vehicle to a stop (i.e., zero velocity) when the leading vehicle stops. However, using only a velocity controller causes the ACC system to operate as a feedback system. That is, the ACC system adjusts acceleration commands based on a difference between desired/target velocity and actual velocity. If the desired velocity is not achieved, the error between desired and actual velocity increases, prompting the velocity controller to adjust its output commands accordingly. This process inherently introduces delays and can lead to overshooting in velocity tracking, oscillations, and other control issues. To mitigate these challenges, incorporating desired acceleration alongside desired velocity acts as a feedforward system thereby reducing delays. Ideally, tracking the acceleration profile ensures tracking of the velocity profile. Notably, however, the acceleration and velocity profiles are geometric and may not account for various disturbances such as road slope and wind resistance. Therefore, in some examples, the velocity controller uses a combination of desired acceleration and desired velocity.

The velocity feedback control algorithm starts by calculating the error between desired and actual velocity to determine the velocity error. Based on this error, proportional and integral gains are determined. Higher velocity errors result in increased gains to ensure a more responsive velocity controller, while lower errors lead to reduced gains to maintain stability. The proportional gain multiplies the error to yield the proportional term, while the integral gain involves summing up adjusted velocity errors using an anti-windup mechanism to derive the integral term. These terms are then added to the desired acceleration command to produce the final output of the velocity controller. Additionally, to simulate different driver behaviors, such as early and gentle deceleration when the vehicle is distant from a stationary vehicle versus late and aggressive deceleration when the vehicle is closer to the stationary vehicle, a threshold is applied to the calculated deceleration command. Thus, the deceleration command may be transmitted to the powertrain module when the deceleration command drops below a specified deceleration limit. This limit can be adjusted according to the driving habits of the vehicle operator to replicate various driver behaviors.

An important consideration for scenarios requiring a stationary stop is that even a slight error in command execution can result in the vehicle colliding with the leading vehicle. To prevent such incidents, a different distance-based controller (e.g., another controller different than the velocity controller) may be activated when the vehicle crosses a specified distance threshold, or its velocity drops below a certain threshold. The distance-based feedback controller relies on the distance and its derivative (i.e., host vehicle velocity) between the host vehicle and the leading object thereby shifting control focus from trajectory planning. This switch may be important when uncertainties or disturbances come into play to emphasize reliability when the vehicle is near the leading vehicle or when its velocity approaches zero. Transitioning between controllers is done smoothly, with rate limiting ensuring gradual shifts from trajectory-based to distance-based feedback control.

With the distance-based controller, two primary states are utilized, namely, distance and the derivative of distance (e.g., equipped vehicle velocity). Here, the error, defined as the difference between the distance of the equipped vehicle from the leading vehicle and the stopping distance, should be zero when the vehicle has come to a complete stop. Similar to the velocity controller, proportional and integral gains may be adjusted based on this distance error. Smaller gains are used when the host vehicle is further from the stopping distance that indicate minor adjustments in braking and deceleration. On the other hand, larger gains are applied when the vehicle exceeds the stopping distance thereby necessitating significant deceleration. The proportional gain multiplies the error to produce the proportional term, while the integral gain sums adjusted velocity errors with an anti-windup mechanism to derive the integral term. To regulate distance changes and prevent overshoot, the derivative of distance (i.e., host vehicle velocity) may be multiplied by a derivative gain which the ACC system uses to control the rate of distance change. The proportional and integral terms are added together from which the derivative term is subtracted to produce the final output command.

As the vehicle approaches a complete stop and the distance from the leading vehicle equals or falls below the stopping distance, the controller fine-tunes ACC commands to gradually reduce acceleration until reaching zero. Notably, this adjustment may occur only when the vehicle is about to stop (i.e., velocity near zero). If the vehicle has already crossed the stopping distance but its velocity remains high, the gains are still tuned to provide high deceleration output. This final phase mimics real-world braking where drivers release the brake pedal gradually to avoid abrupt changes in acceleration that could cause discomfort due to the abrupt acceleration change. This approach ensures smooth and safe vehicle stopping, replicating principles applied in real-world vehicle operations. Finally, the sum of proportional, integral, and derivative terms is added to generate the overall acceleration command from this second controller (e.g., the distance-based controller).

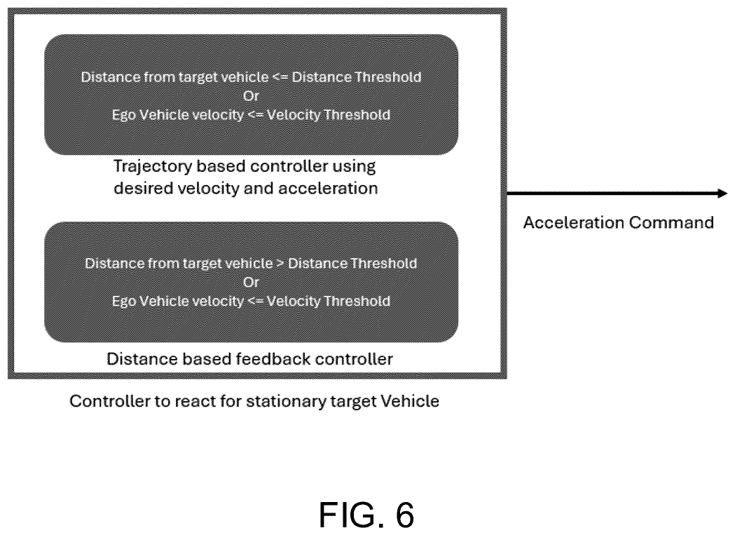

FIG. 6 illustrates the schematic diagram of the controller implementation by depicting both trajectory-based control, using desired velocity and acceleration, a distance-based feedback controller, and conditions under which each controller becomes active. The diagram shows a primary controller block which logically selects between two different control strategies to produce a final acceleration command. The first strategy, shown in the upper portion of the block, is a trajectory-based controller using desired velocity and acceleration. The controller selects the first strategy when either the distance from the target vehicle is less than or equal to the distance threshold or the velocity of the equipped vehicle is less than or equal to the velocity threshold. The second strategy, shown in the lower portion of the block, is a distance-based feedback controller. The second strategy is selected when either the distance from the target vehicle is greater than the distance threshold or the velocity of the equipped vehicle is greater than the velocity threshold. Therefore, the system evaluates the current velocity of the equipped vehicle and the distance from the target vehicle against predefined thresholds to determine which of the two control modes, trajectory-based or distance-based, will be used to determine the acceleration command for controlling the vehicle.

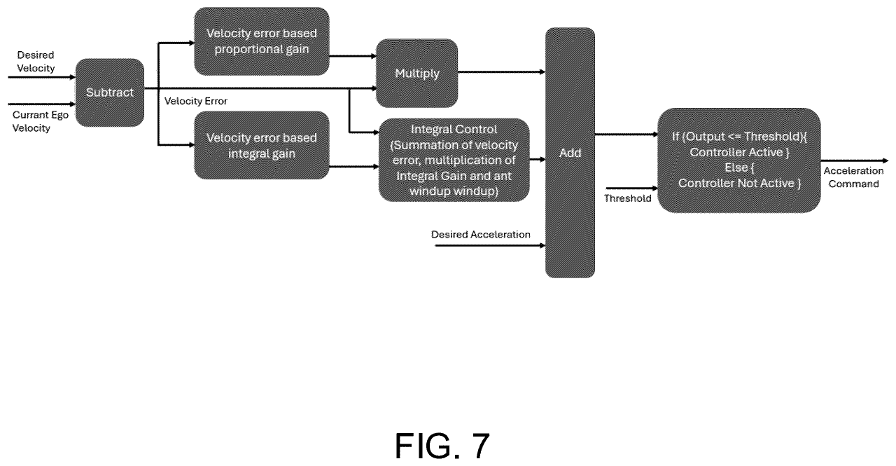

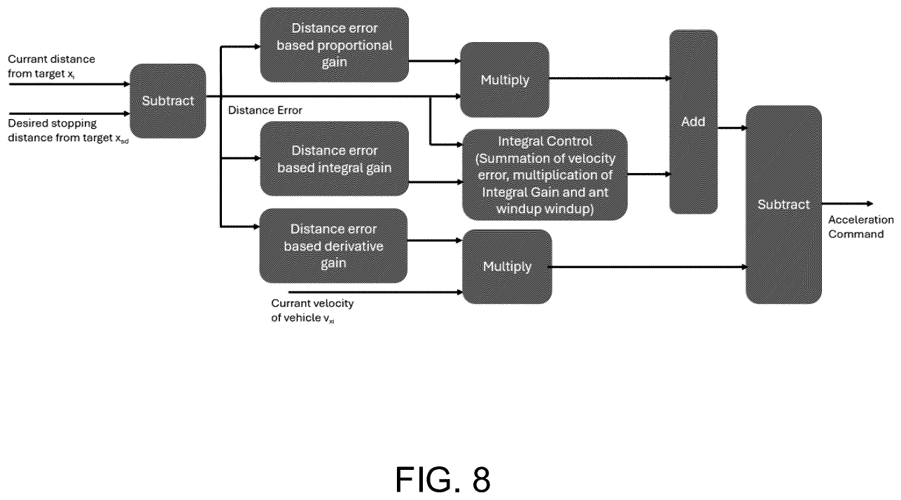

FIGS. 7 and 8 show diagrams detailing the implementation and components of the first strategy and the second strategy. FIG. 7 provides details of trajectory-based control using desired velocity and acceleration, while FIG. 8 provides details of the distance-based feedback controller. The trajectory-based control first determines a velocity error by subtracting the current velocity of the equipped vehicle from the desired velocity. The velocity error is processed through proportional and integral paths. The proportional path multiplies the velocity error by a velocity error based proportional gain. The integral path uses sums the velocity error over time, applies a velocity error based integral gain, and includes an anti-windup mechanism. The resulting proportional term, integral term, and a feedforward desired acceleration are combined in an add block. The sum, representing a preliminary command, is then evaluated by a logic gate. If the command is less than or equal to a specified threshold, the controller is active and outputs the final acceleration command. Otherwise, the controller is not active.

FIG. 8 provides a detailed block diagram of the distance-based feedback controller. This controller functions as a proportional-integral-derivative (PID) control system that primarily uses distance and velocity to regulate vehicle speed. The process begins by determining a distance error, which is the difference between the current distance from the target (xᵢ) and the desired stopping distance from the target (x_{sd}). The distance error is then used to determine three separate control terms. The proportional term is generated by multiplying the distance error by a distance error based proportional gain. The integral term is produced by a summation of the distance error with an associated distance error based integral gain and an anti-windup function to prevent control saturation. The proportional term and the integral term are then summed in an add block. The derivative term is determined using the current velocity of the equipped vehicle as the derivative of the distance error, which is then multiplied by a distance error based derivative gain. In the final step, the derivative term is subtracted from the sum of the proportional and integral terms to generate the final acceleration command for the vehicle.

Thus, the ACC system provides an ADAS feature that reacts to a stationary leading vehicle, bringing the equipped or host vehicle to a complete stop while maintaining a specified distance, also referred to as the stopping distance, by generating a longitudinal acceleration command based on sensor data. A trajectory generation module determines polynomial trajectories for velocity and acceleration relative to the distance from the leading vehicle. The goal is to achieve the desired end state of bringing the equipped vehicle to a complete stop while maintaining a predefined stopping distance from the leading vehicle. A trajectory generation module may determine and output the desired velocity and acceleration to achieve the end target state. A longitudinal control module utilizes the desired velocity, desired acceleration, and information on the leading vehicle and equipped vehicles to generate longitudinal acceleration commands.

The trajectory generation module includes a function that determines coefficients for a second-order polynomial representing vehicle acceleration and a third-order polynomial representing the square of the vehicle's velocity over distance. This enables the equipped vehicle to achieve its final state of coming to a complete stop while maintaining the stopping distance from the leading vehicle. The controller module may include two distinct controllers, namely, a trajectory-based controller and a distance-based feedback controller. In some examples, only one controller is active at any given time which is determined by the velocity of the equipped vehicle or the distance of the equipped vehicle from the leading vehicle. The transition between controllers is smooth and gradual due to rate limiting.

The trajectory-based controller using desired velocity and acceleration controller processes desired and actual velocity errors as inputs for its proportional and integral controllers. This controller acts as a feedback mechanism, addressing uncertainties and disturbances. It adjusts the gains of the proportional and integral controllers based on the magnitude of the velocity error. Lower velocity errors minimize gains to produce smooth output commands, while larger errors increase gains to quickly achieve the desired velocity. The desired acceleration output from the trajectory is added to the proportional and integral controllers to finalize the acceleration command. Integrating desired acceleration reduces the weight of the proportional and integral terms, thereby minimizing system delays and lags. The desired command is sent to the powertrain module only when it falls below a specified threshold. This approach effectively simulates various driver behaviors, such as early and gentle deceleration when distant from a stationary vehicle versus late and aggressive deceleration when closer.

The distance-based feedback controller may use distance errors, defined as the difference between the equipped vehicle's distance from the leading vehicle and the stopping distance, as inputs for its proportional and integral controllers. To regulate distance changes and prevent overshoot, the derivative of distance (i.e., equipped vehicle velocity) is multiplied by a derivative gain. This step controls the rate of distance change, effectively damping oscillations and preventing overshoot and adjusts the gains of the proportional, integral, and derivative controllers based on the magnitude of the distance error. Minimal gains are applied during periods of low positive distance errors, indicating the equipped vehicle has not crossed the stopping distance threshold, to ensure smooth output commands. Conversely, higher gains are used during significant distance errors to rapidly track the desired distance. As the vehicle approaches a complete stop, and the vehicle velocity is nearing the stopping distance or has already crossed the stopping distance, the controller fine-tunes ACC commands to gradually reduce acceleration, ensuring a smooth and safe stop. This gradual adjustment mimics real-world braking scenarios, preventing abrupt changes in acceleration at the stop that could cause discomfort due to high jerk. This setup ensures precise control and safety in bringing the equipped vehicle to a stop while maintaining a safe distance from the leading vehicle, employing sophisticated trajectory and feedback control mechanisms tailored to various driving conditions and scenarios.

As described above, the vehicular sensing system may determine (e.g., by processing sensor data) a leading vehicle is stopped in front of the equipped vehicle and within a traffic lane the equipped vehicle is currently traveling along and determine a distance between the equipped vehicle and the leading vehicle is greater than a threshold distance. Moreover, the vehicular sensing system may determine that the leading vehicle is stopped in front of the equipped vehicle or traveling at a slow speed (such as may occur in a traffic jam or approaching an intersection or the like) that is less than a threshold speed (e.g., less than 20 mph, 10 mph, 5 mph, etc.). The vehicular sensing system utilizes different control modes depending on the state of the equipped vehicle relative to the leading vehicle. As such, in a first mode of operation, the vehicular sensing system may determine a velocity profile based on a speed of the equipped vehicle and the determined distance between the equipped vehicle and the leading vehicle. The velocity profile represents a smooth, dynamically generated trajectory, for instance using the polynomial functions described herein, designed for a comfortable deceleration over a longer distance. The system may utilize a trajectory-based controller or velocity controller (as shown in FIG. 7) to follow the velocity profile.

With the equipped vehicle being at a distance from the leading vehicle that is greater than the threshold distance and with the speed of the equipped vehicle being greater than another threshold speed, the vehicular sensing system may control speed of the equipped vehicle based on the determined velocity profile as the equipped vehicle approaches the leading vehicle (e.g., approaches the leading vehicle while decelerating based on the velocity profile). Here, the control may be achieved by determining a velocity error between a target velocity from the profile and the actual vehicle velocity and using this error and its corresponding gain to generate an acceleration command. For example, when the equipped vehicle is sufficiently far away from the stopped leading vehicle (e.g., 500 feet from the stopped leading vehicle), the vehicular sensing system may control deceleration of the equipped vehicle to slow down due to the stopped leading vehicle based on the velocity profile.

However, since relatively small errors in velocity based control of the vehicle may cause the equipped vehicle to collide with the stopped leading vehicle may switch to a second, safety-focused control mode when the vehicle nears a leading vehicle. The vehicular sensing system may switch to controlling the deceleration of the equipped vehicle to slow down and stop for the stopped leading vehicle based on a distance profile when the vehicle is sufficiently close to the leading vehicle or moving at a velocity under a speed threshold. To that end, the vehicular sensing system may determine that the distance between the equipped vehicle and the leading vehicle fails to satisfy the threshold distance (e.g., is less than or less than or equal to) or that the speed of the equipped vehicle is less than or equal to another threshold speed, while controlling speed of the equipped vehicle based on the determined velocity profile and as the equipped vehicle approaches the leading vehicle. For example, while the vehicle is decelerating according to the velocity profile, the distance between the equipped vehicle and the leading vehicle may become smaller such that the distance fails to satisfy the threshold distance (e.g., is less than the threshold distance). Thus, the vehicle may switch to controlling the speed of the equipped vehicle to be based on a distance profile rather than being controlled based on the velocity profile. Controlling the speed of the equipped vehicle based on the distance profile establishes and maintains a gap between the equipped vehicle and the leading vehicle.

The transition from the velocity-based controller to the distance-based controller may be smoothed by, for example, limiting the rate of acceleration change of the equipped vehicle. Here, the vehicular sensing system determines the distance profile based on the speed of the equipped vehicle and the distance between the equipped vehicle and the leading vehicle. The distance profile may include a gap that the equipped vehicle maintains relative to the leading vehicle when the equipped vehicle slows or stops behind the leading vehicle. The second mode utilizes a distance-based feedback controller or distance controller (as shown in FIG. 8) that determines a distance error based on the desired final gap and the actual distance and uses this error and its corresponding gain to robustly control the final stopping position.

Thus, the vehicular sensing system brings an equipped vehicle to a stop behind a stationary or slow-moving leading vehicle. The system achieves this by combining combines two distinct control modes to optimize for both passenger comfort and safety throughout the stopping maneuver. In a first mode, active when the equipped vehicle is at a sufficient distance from the leading vehicle, the system follows a dynamically generated, smooth velocity and acceleration trajectory to ensure a comfortable and human-like deceleration. When the vehicle enters a more short-range zone, the system transitions to a second control mode. The second control mode utilizes a robust distance-based feedback controller that precisely manages the final stopping gap between the vehicles, prioritizing positional accuracy over pre-planned trajectory adherence. The system continuously monitors the distance to the leading vehicle and the equipped vehicle's own speed. Upon determining that the distance has dropped below a predefined threshold, or that the vehicle's speed has fallen below a certain low-speed threshold, the system switches from the trajectory-following controller to the distance-based feedback controller. This dual-mode, state-dependent architecture ensures that the control strategy is based on the current phase of the stopping maneuver, thereby providing a comprehensive solution that achieves a high degree of safety without sacrificing ride comfort.

The camera or sensor may comprise any suitable camera or sensor. Optionally, the camera may comprise a “smart camera” that includes the imaging sensor array and associated circuitry and image processing circuitry and electrical connectors and the like as part of a camera module, such as by utilizing aspects of the vision systems described in U.S. Pat. Nos. 10,099,614 and/or 10,071,687, which are hereby incorporated herein by reference in their entireties.

The system includes an image processor operable to process image data captured by the camera or cameras, such as for detecting objects or other vehicles or pedestrians or the like in the field of view of one or more of the cameras. For example, the image processor may comprise an image processing chip selected from the EYEQ family of image processing chips available from Mobileye Vision Technologies Ltd. of Jerusalem, Israel, and may include object detection software (such as the types described in U.S. Pat. Nos. 7,855,755; 7,720,580 and/or 7,038,577, which are hereby incorporated herein by reference in their entireties), and may analyze image data to detect vehicles and/or other objects. Responsive to such image processing, and when an object or other vehicle is detected, the system may generate an alert to the driver of the vehicle and/or may generate an overlay at the displayed image to highlight or enhance display of the detected object or vehicle, in order to enhance the driver's awareness of the detected object or vehicle or hazardous condition during a driving maneuver of the equipped vehicle.

The vehicle may include any type of sensor or sensors, such as imaging sensors or radar sensors or lidar sensors or ultrasonic sensors or the like. The imaging sensor of the camera may capture image data for image processing and may comprise, for example, a two dimensional array of a plurality of photosensor elements arranged in at least 640 columns and 480 rows (at least a 640×480 imaging array, such as a megapixel imaging array or the like), with a respective lens focusing images onto respective portions of the array. The photosensor array may comprise a plurality of photosensor elements arranged in a photosensor array having rows and columns. The imaging array may comprise a CMOS imaging array having at least 300,000 photosensor elements or pixels, preferably at least 500,000 photosensor elements or pixels and more preferably at least one million photosensor elements or pixels or at least three million photosensor elements or pixels or at least five million photosensor elements or pixels arranged in rows and columns. The imaging array may capture color image data, such as via spectral filtering at the array, such as via an RGB (red, green and blue) filter or via a red/red complement filter or such as via an RCC (red, clear, clear) filter or the like. The logic and control circuit of the imaging sensor may function in any known manner, and the image processing and algorithmic processing may comprise any suitable means for processing the images and/or image data.

For example, the vision system and/or processing and/or camera and/or circuitry may utilize aspects described in U.S. Pat. Nos. 9,233,641; 9,146,898; 9,174,574; 9,090,234; 9,077,098; 8,818,042; 8,886,401; 9,077,962; 9,068,390; 9,140,789; 9,092,986; 9,205,776; 8,917,169; 8,694,224; 7,005,974; 5,760,962; 5,877,897; 5,796,094; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; 7,859,565; 5,550,677; 5,670,935; 6,636,258; 7,145,519; 7,161,616; 7,230,640; 7,248,283; 7,295,229; 7,301,466; 7,592,928; 7,881,496; 7,720,580; 7,038,577; 6,882,287; 5,929,786 and/or 5,786,772, and/or U.S. Publication Nos. US-2014-0340510; US-2014-0313339; US-2014-0347486; US-2014-0320658; US-2014-0336876; US-2014-0307095; US-2014-0327774; US-2014-0327772; US-2014-0320636; US-2014-0293057; US-2014-0309884; US-2014-0226012; US-2014-0293042; US-2014-0218535; US-2014-0218535; US-2014-0247354; US-2014-0247355; US-2014-0247352; US-2014-0232869; US-2014-0211009; US-2014-0160276; US-2014-0168437; US-2014-0168415; US-2014-0160291; US-2014-0152825; US-2014-0139676; US-2014-0138140; US-2014-0104426; US-2014-0098229; US-2014-0085472; US-2014-0067206; US-2014-0049646; US-2014-0052340; US-2014-0025240; US-2014-0028852; US-2014-005907; US-2013-0314503; US-2013-0298866; US-2013-0222593; US-2013-0300869; US-2013-0278769; US-2013-0258077; US-2013-0258077; US-2013-0242099; US-2013-0215271; US-2013-0141578 and/or US-2013-0002873, which are all hereby incorporated herein by reference in their entireties. The system may communicate with other communication systems via any suitable means, such as by utilizing aspects of the systems described in U.S. Pat. Nos. 10,071,687; 9,900,490; 9,126,525 and/or 9,036,026, which are hereby incorporated herein by reference in their entireties.

The system may utilize sensors, such as radar sensors or imaging radar sensors or lidar sensors or the like, to detect presence of and/or range to objects and/or other vehicles and/or pedestrians. The sensing system may utilize aspects of the systems described in U.S. Pat. Nos. 10,866,306; 9,954,955; 9,869,762; 9,753,121; 9,689,967; 9,599,702; 9,575,160; 9,146,898; 9,036,026; 8,027,029; 8,013,780; 7,408,627; 7,405,812; 7,379,163; 7,379,100; 7,375,803; 7,352,454; 7,340,077; 7,321,111; 7,310,431; 7,283,213; 7,212,663; 7,203,356; 7,176,438; 7,157,685; 7,053,357; 6,919,549; 6,906,793; 6,876,775; 6,710,770; 6,690,354; 6,678,039; 6,674,895 and/or 6,587,186, and/or U.S. Publication Nos. US-2019-0339382; US-2018-0231635; US-2018-0045812; US-2018-0015875; US-2017-0356994; US-2017-0315231; US-2017-0276788; US-2017-0254873; US-2017-0222311 and/or US-2010-0245066, which are hereby incorporated herein by reference in their entireties.

The radar sensors of the sensing system each comprise a plurality of transmitters that transmit radio signals via a plurality of antennas, a plurality of receivers that receive radio signals via the plurality of antennas, with the received radio signals being transmitted radio signals that are reflected from an object present in the field of sensing of the respective radar sensor. The system includes an ECU or control that includes a data processor for processing sensor data captured by the radar sensors. The ECU or sensing system may be part of a driving assist system of the vehicle, with the driving assist system controlling at least one function or feature of the vehicle (such as to provide autonomous driving control of the vehicle) responsive to processing of the data captured by the radar sensors.

Changes and modifications in the specifically described embodiments can be carried out without departing from the principles of the invention, which is intended to be limited only by the scope of the appended claims, as interpreted according to the principles of patent law including the doctrine of equivalents.

1. A vehicular driving assist system, the vehicular driving assist system comprising:
a sensor disposed at a vehicle equipped with the vehicular driving assist system and sensing exterior of the equipped vehicle;
wherein the sensor is operable to capture sensor data;
an electronic control unit (ECU) comprising electronic circuitry and associated software;
wherein sensor data captured by the sensor is transferred to the ECU;
wherein the electronic circuitry of the ECU comprises a data processor for processing sensor data captured by the sensor and transferred to the ECU;
wherein the vehicular driving assist system, via processing at the ECU of captured sensor data, determines presence of a leading vehicle in front of the equipped vehicle and within a traffic lane along which the equipped vehicle is traveling;
wherein the vehicular driving assist system, responsive to determining presence of the leading vehicle in front of the equipped vehicle and within the traffic lane along which the equipped vehicle is traveling, determines distance between the equipped vehicle and the leading vehicle;
wherein, responsive to (i) determining that the leading vehicle is stopped in front of the equipped vehicle or traveling at speed that is less than a threshold speed and (ii) the determined distance being greater than a threshold distance, the vehicular driving assist system determines a velocity profile for the equipped vehicle to follow based on (a) speed of the equipped vehicle and (b) the determined distance between the equipped vehicle and the leading vehicle;
wherein, with the equipped vehicle at a distance from the leading vehicle that is greater than the threshold distance, and with speed of the equipped vehicle being greater than speed of the leading vehicle, the vehicular driving assist system controls speed of the equipped vehicle based on the determined velocity profile to control slowing of the equipped vehicle as the equipped vehicle approaches the leading vehicle;
wherein the vehicular driving assist system, while controlling speed of the equipped vehicle based on the determined velocity profile as the equipped vehicle approaches the leading vehicle, and responsive to the determined distance between the equipped vehicle and the leading vehicle being less than or equal to the threshold distance, determines a distance profile for the equipped vehicle to follow based on (a) speed of the equipped vehicle and (b) the determined distance between the equipped vehicle and the leading vehicle; and
wherein, with the equipped vehicle being at a distance from the leading vehicle that is less than or equal to the threshold distance, the vehicular driving assist system controls speed of the equipped vehicle based on the determined distance profile to establish and maintain a target gap between the equipped vehicle and the leading vehicle.

2. The vehicular driving assist system of claim 1, wherein the determined distance profile is based on the target gap that the equipped vehicle maintains relative to the leading vehicle when the equipped vehicle slows or stops behind the leading vehicle.

3. The vehicular driving assist system of claim 1, wherein the vehicular driving assist system, responsive to determining that the determined distance between the equipped vehicle and the leading vehicle is less than or equal to the threshold distance, switches from controlling speed of the equipped vehicle based on the determined velocity profile to controlling speed of the equipped vehicle based on the determined distance profile.

4. The vehicular driving assist system of claim 3, wherein switching from controlling speed of the equipped vehicle based on the determined velocity profile to controlling speed of the equipped vehicle based on the determined distance profile comprises limiting a rate of acceleration of the equipped vehicle.

5. The vehicular driving assist system of claim 1, wherein the vehicular driving assist system controls speed of the equipped vehicle based on the determined velocity profile further responsive to determining that speed of the equipped vehicle is greater than another threshold speed.

6. The vehicular driving assist system of claim 1, wherein the vehicular driving assist system controls speed of the equipped vehicle based on the determined distance profile further responsive to determining that speed of the equipped vehicle is less than or equal to another threshold speed.

7. The vehicular driving assist system of claim 1, wherein the vehicular driving assist system controls speed of the equipped vehicle based on the determined velocity profile using a velocity controller.

8. The vehicular driving assist system of claim 1, wherein the vehicular driving assist system controls speed of the equipped vehicle based on the determined distance profile using a distance controller.

9. The vehicular driving assist system of claim 1, wherein controlling speed of the equipped vehicle based on the determined velocity profile comprises (i) determining a velocity error based on a target velocity from the determined velocity profile and an actual velocity of the equipped vehicle and (ii) determining a gain based on the determined velocity error.

10. The vehicular driving assist system of claim 1, wherein controlling speed of the equipped vehicle based on the determined distance profile comprises (i) determining a distance error based on the target gap and an actual distance between the equipped vehicle and the leading vehicle and (ii) determining a gain based on the determined distance error.

11. The vehicular driving assist system of claim 1, wherein the sensor comprises a forward-viewing camera disposed at an in-cabin side of a windshield of the equipped vehicle, the forward-viewing camera viewing forward of the equipped vehicle through the windshield.

12. The vehicular driving assist system of claim 11, wherein the vehicular driving assist system, responsive to processing at the ECU of sensor data captured by the forward-viewing camera, determines lane markers of at least the traffic lane the equipped vehicle is currently traveling along.

13. The vehicular driving assist system of claim 12, wherein the sensor comprises a plurality of sensors, and wherein the plurality of sensors comprises at least one non-imaging sensor selected from the group consisting of (i) a forward-sensing radar sensor, (ii) a forward-sensing lidar sensor and (iii) a forward-sensing ultrasonic sensor, and wherein the distance between the equipped vehicle and the leading vehicle is determined by processing sensor data captured by the at least one non-imaging sensor.

14. The vehicular driving assist system of claim 1, wherein the vehicular driving assist system controls speed of the equipped vehicle by controlling braking of the equipped vehicle.

15. The vehicular driving assist system of claim 1, wherein the threshold speed comprises a speed that is less than or equal to 20 miles per hour.

16. A vehicular driving assist system, the vehicular driving assist system comprising:
a sensor disposed at a vehicle equipped with the vehicular driving assist system and sensing exterior of the equipped vehicle;
wherein the sensor is operable to capture sensor data;
an electronic control unit (ECU) comprising electronic circuitry and associated software;
wherein sensor data captured by the sensor is transferred to the ECU;
wherein the electronic circuitry of the ECU comprises a data processor for processing sensor data captured by the sensor and transferred to the ECU;
wherein the vehicular driving assist system, via processing at the ECU of captured sensor data, determines presence of a leading vehicle in front of the equipped vehicle and within a traffic lane along which the equipped vehicle is traveling;
wherein the vehicular driving assist system, responsive to determining presence of the leading vehicle in front of the equipped vehicle and within the traffic lane along which the equipped vehicle is traveling, determines distance between the equipped vehicle and the leading vehicle;
wherein, responsive to (i) determining that the leading vehicle is stopped in front of the equipped vehicle or traveling at speed that is less than a threshold speed and (ii) the determined distance being greater than a threshold distance, the vehicular driving assist system determines a velocity profile for the equipped vehicle to follow based on (a) speed of the equipped vehicle and (b) the determined distance between the equipped vehicle and the leading vehicle;
wherein, with the equipped vehicle at a distance from the leading vehicle that is greater than the threshold distance, and with speed of the equipped vehicle being greater than speed of the leading vehicle, the vehicular driving assist system controls speed of the equipped vehicle based on the determined velocity profile to control slowing of the equipped vehicle as the equipped vehicle approaches the leading vehicle;
wherein the vehicular driving assist system, while controlling speed of the equipped vehicle based on the determined velocity profile as the equipped vehicle approaches the leading vehicle, and responsive to the determined distance between the equipped vehicle and the leading vehicle being less than or equal to the threshold distance, determines a distance profile for the equipped vehicle to follow based on (a) speed of the equipped vehicle and (b) the determined distance between the equipped vehicle and the leading vehicle, and wherein the determined distance profile is based on a target gap that the equipped vehicle maintains relative to the leading vehicle when the equipped vehicle slows or stops behind the leading vehicle;
wherein the vehicular driving assist system, responsive to determining that the determined distance between the equipped vehicle and the leading vehicle is less than or equal to the threshold distance, switches from controlling speed of the equipped vehicle based on the determined velocity profile to controlling speed of the equipped vehicle based on the determined distance profile; and
wherein, with the equipped vehicle being at a distance from the leading vehicle that is less than or equal to the threshold distance, the vehicular driving assist system controls speed of the equipped vehicle based on the determined distance profile to establish and maintain the target gap between the equipped vehicle and the leading vehicle.

17. The vehicular driving assist system of claim 16, wherein switching from controlling speed of the equipped vehicle based on the determined velocity profile to controlling speed of the equipped vehicle based on the determined distance profile comprises limiting a rate of acceleration of the equipped vehicle.

18. The vehicular driving assist system of claim 16, wherein controlling speed of the equipped vehicle based on the determined velocity profile comprises (i) determining a velocity error based on a target velocity from the determined velocity profile and an actual velocity of the equipped vehicle and (ii) determining a gain based on the determined velocity error.

19. The vehicular driving assist system of claim 16, wherein controlling speed of the equipped vehicle based on the determined distance profile comprises (i) determining a distance error based on the target gap and an actual distance between the equipped vehicle and the leading vehicle and (ii) determining a gain based on the determined distance error.

20. A vehicular driving assist system, the vehicular driving assist system comprising:
a sensor disposed at a vehicle equipped with the vehicular driving assist system and sensing exterior of the equipped vehicle;
wherein the sensor is operable to capture sensor data;
an electronic control unit (ECU) comprising electronic circuitry and associated software;
wherein sensor data captured by the sensor is transferred to the ECU;
wherein the electronic circuitry of the ECU comprises a data processor for processing sensor data captured by the sensor and transferred to the ECU;
wherein the vehicular driving assist system, via processing at the ECU of captured sensor data, determines presence of a leading vehicle in front of the equipped vehicle and within a traffic lane along which the equipped vehicle is traveling;
wherein the vehicular driving assist system, responsive to determining presence of the leading vehicle in front of the equipped vehicle and within the traffic lane along which the equipped vehicle is traveling, determines distance between the equipped vehicle and the leading vehicle;
wherein, responsive to (i) determining that the leading vehicle is stopped in front of the equipped vehicle or traveling at speed that is less than a threshold speed and (ii) the determined distance being greater than a threshold distance, the vehicular driving assist system determines a velocity profile for the equipped vehicle to follow based on (a) speed of the equipped vehicle and (b) the determined distance between the equipped vehicle and the leading vehicle;
wherein, with the equipped vehicle at a distance from the leading vehicle that is greater than the threshold distance, and with speed of the equipped vehicle being greater than speed of the leading vehicle, the vehicular driving assist system controls speed of the equipped vehicle based on the determined velocity profile to control slowing of the equipped vehicle as the equipped vehicle approaches the leading vehicle, wherein controlling speed of the equipped vehicle based on the determined velocity profile comprises (i) determining a velocity error based on a target velocity from the determined velocity profile and an actual velocity of the equipped vehicle and (ii) determining a gain based on the determined velocity error;
wherein the vehicular driving assist system, while controlling speed of the equipped vehicle based on the determined velocity profile as the equipped vehicle approaches the leading vehicle, and responsive to the determined distance between the equipped vehicle and the leading vehicle being less than or equal to the threshold distance, determines a distance profile for the equipped vehicle to follow based on (a) speed of the equipped vehicle and (b) the determined distance between the equipped vehicle and the leading vehicle; and
wherein, with the equipped vehicle being at a distance from the leading vehicle that is less than or equal to the threshold distance, the vehicular driving assist system controls speed of the equipped vehicle based on the determined distance profile to establish and maintain a target gap between the equipped vehicle and the leading vehicle, wherein controlling speed of the equipped vehicle based on the determined distance profile comprises (i) determining a distance error based on the target gap and an actual distance between the equipped vehicle and the leading vehicle and (ii) determining a gain based on the determined distance error.

21. The vehicular driving assist system of claim 20, wherein the determined distance profile is based on the target gap that the equipped vehicle maintains relative to the leading vehicle when the equipped vehicle slows or stops behind the leading vehicle.

22. The vehicular driving assist system of claim 20, wherein the vehicular driving assist system, responsive to determining that the determined distance between the equipped vehicle and the leading vehicle is less than or equal to the threshold distance, switches from controlling speed of the equipped vehicle based on the determined velocity profile to controlling speed of the equipped vehicle based on the determined distance profile.

23. The vehicular driving assist system of claim 22, wherein switching from controlling speed of the equipped vehicle based on the determined velocity profile to controlling speed of the equipped vehicle based on the determined distance profile comprises limiting a rate of acceleration of the equipped vehicle.
